(19) United States
(12) Patent Application Publication
(10) Pub. No.: US 2013/0320793 A1
(43) Pub. Date: Dec. 5, 2013

(54) SPINDLE MOTOR

(71) Applicants: Seung Heon Han, Gyunggi-do (KR); Hyun Ho Shin, Gyunggi-do (KR); Sung Yeol Park, Gyunggi-do (KR); Jung Tae Park, Gyunggi-do (KR); Hong Joo Lee, Gyunggi-do (KR); Jung Eun Noh, Gyunggi-do (KR); Ju Ho Kim, Gyunggi-do (KR)

(72) Inventors: Seung Heon Han, Gyunggi-do (KR); Hyun Ho Shin, Gyunggi-do (KR); Sung Yeol Park, Gyunggi-do (KR); Jung Tae Park, Gyunggi-do (KR); Hong Joo Lee, Gyunggi-do (KR); Jung Eun Noh, Gyunggi-do (KR); Ju Ho Kim, Gyunggi-do (KR)

(73) Assignee: SAMSUNG ELECTRO-MECHANICS CO., LTD., Gyunggi-do (KR)

(21) Appl. No.: 13/587,600

(22) Filed: Aug. 16, 2012

(30) Foreign Application Priority Data
May 31, 2012 (KR) 10-2012-0058234

(51) Int. Cl. H02K 5/16

(52) U.S. Cl. 310/90

(57) ABSTRACT

Disclosed herein is a spindle motor including: a shaft forming the center of rotation of the motor; a sleeve receiving the shaft therein and rotatably supporting the shaft; a thrust plate press-fitted into the shaft so as to be perpendicular to an axial direction of the shaft; and a sealing cap spaced apart from the thrust plate in an upward axial direction and bent to enclose an outer side surface of the sleeve to thereby be coupled to the thrust plate, wherein the sealing cap is provided with a sealing part having concave parts and convex parts alternately formed along an inner peripheral surface thereof in a radial direction.

### CROSS REFERENCE TO RELATED APPLICATION

This application claims the benefit of Korean Patent Application No. 10-2012-0058234, filed on May 31, 2012, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, a spindle motor, which belongs to a brushless-DC motor (BLDC), has been widely used as a laser beam scanner motor for a laser printer, a motor for a floppy disk drive (FDD), a motor for an optical disk drive such as a compact disk (CD) or a digital versatile disk (DVD), or the like, in addition to a motor for a hard disk drive.

Recently, in a device such as a hard disk drive requiring high capacity and high speed driving force, a spindle motor including a fluid dynamic pressure bearing having lower driving friction as compared to an existing ball bearing has generally been used in order to minimize generation of noise and non repeatable run out (NRRO), which is vibration generated at the time of use of a ball bearing. As described in US Patent Laid-Open Publication No. 20050094908 published by the United States Patents and Trademark Office, in the fluid dynamic pressure bearing, a thin oil film is basically formed between a rotor and a stator, such that the rotor and the stator are supported by pressure generated at the time of rotation. Therefore, the rotor and stator do not contact each other, such that frictional load is reduced. In the spindle motor using the fluid dynamic pressure bearing, lubricating oil (hereinafter, referred to as an ‘operating fluid’) maintains a shaft of the motor rotating a disk only with dynamic pressure (indicating pressure returning oil pressure to the center by centrifugal force of the shaft). Therefore, the spindle motor using the fluid dynamic pressure bearing is distinguished from a ball bearing spindle motor in which the shaft is supported by an iron ball.

When the fluid dynamic pressure bearing is used in the spindle motor, the rotor is supported by the fluid, such that a noise amount generated in the motor is small, power consumption is low, and impact resistance is excellent.

Particularly, in the case of the spindle motor using the fluid dynamic pressure bearing, it is very important to store and seal the operating fluid forming the fluid dynamic pressure bearing. According to a design of a sealing part of the operating fluid, the operating fluid of the fluid dynamic pressure bearing may asymmetrically flow. In addition, due to complexity of a structure or an increase in the number of component for sealing the operating fluid, operational performance the spindle motor using the fluid dynamic pressure bearing or reliability of driving of the spindle motor is deteriorated.

### SUMMARY OF THE INVENTION

The present invention has been made in an effort to provide a spindle motor capable of more stably operating a fluid dynamic pressure bearing and improving reliability of driving by structurally changing a shape of a sealing cap forming a sealing part of the spindle motor using the fluid dynamic pressure bearing.

According to a preferred embodiment of the present invention, there is provided a spindle motor including: a shaft forming the center of rotation of the motor; a sleeve receiving the shaft therein and rotatably supporting the shaft; a thrust plate press-fitted into the shaft so as to be perpendicular to an axial direction of the shaft; and a sealing cap spaced apart from the thrust plate in an upward axial direction and bent to enclose an outer side surface of the sleeve to thereby be coupled to the thrust plate, wherein the sealing cap is provided with a sealing part having concave parts and convex parts alternately formed along an inner peripheral surface thereof in a radial direction.

The concave part of the sealing part may have a groove shape in which a width thereof is narrowed toward an inner side surface thereof and the convex part of the sealing part may be formed to be protruded so that a width thereof is narrowed toward an outer side surface thereof.

The concave part and the convex part may be formed in a saw-tooth shape.

The sealing cap may include: a first plate part facing the thrust plate; and a second plate part extended from the first plate part and bent in a downward axial direction to thereby be coupled to the outer side surface of the sleeve, and the sealing part may be formed along an inner peripheral surface of the first plate part in the radial direction.

The first plate part and the thrust plate may be spaced from each other so as to face each other in parallel with each other.

A spaced space formed by the first plate part and the thrust plate facing each other may be formed so as to have an axial interval gradually increased toward the center of rotation of the motor.

The concave part of the sealing part may have a groove shape in which a width thereof is narrowed toward an inner side surface thereof and the convex part of the sealing part may be formed to be protruded so that a width thereof is narrowed toward an outer side surface thereof.

The concave part and the convex part of the sealing part may be formed in a saw-tooth shape.

According to another preferred embodiment of the present invention, there is provided a spindle motor including: a shaft forming the center of rotation of the motor; a sleeve receiving the shaft therein and rotatably supporting the shaft; and a hub coupled to an upper portion of the shaft in an axial direction and having a protrusion part formed so as to face an outer peripheral surface of the sleeve in a radial direction, wherein a lower end surface of the protrusion part in the axial direction is provided with a sealing part having concave parts and convex parts alternately formed along a circumference thereof.

The concave part of the sealing part may have a groove shape in which a width thereof is narrowed toward an inner side surface thereof and the convex part of the sealing part may be formed to be protruded so that a width thereof is narrowed toward an outer side surface thereof.

The concave part and the convex part of the sealing part may be formed in a saw-tooth shape.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a spindle motor according to a preferred embodiment of the present invention;

FIG. 2 is a partially enlarged view of the part A of FIG. 1;

FIG. 3 is a partial perspective view of a sealing cap according to the preferred embodiment of the present invention;

FIG. 4 is a plan view of the sealing cap according to the preferred embodiment of the present invention;

FIG. 5 is a cross-sectional view of a spindle motor according to another embodiment of the present invention; and

FIG. 6 is a bottom perspective view of a sealing part according to another embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

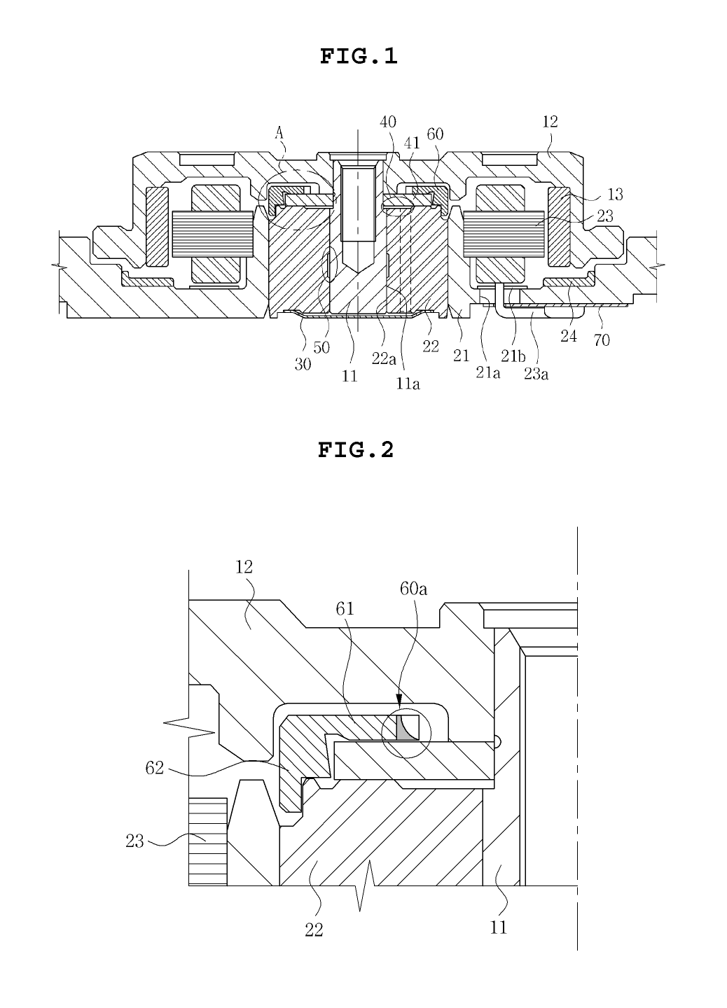

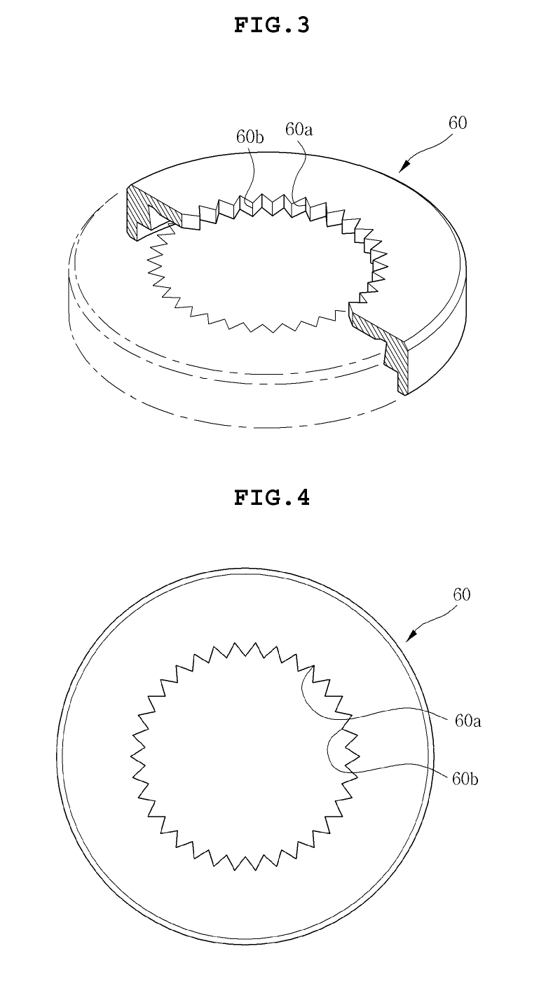

FIG. 1 is a cross-sectional view of a spindle motor according to a preferred embodiment of the present invention; FIG. 2 is a partially enlarged view of the part A of FIG. 1; FIG. 3 is a partial perspective view of a sealing cap according to the preferred embodiment of the present invention; and FIG. 4 is a plan view of the sealing cap according to the preferred embodiment of the present invention.

The spindle motor according to the preferred embodiment of the present invention is configured to include a shaft 11 forming the center of rotation of the motor, a sleeve 22 receiving the shaft 11 therein and rotatably supporting the shaft 11, a thrust plate 41 press-fitted into the shaft 11 so as to be perpendicular to an axial direction of the shaft 11, and a sealing cap 60 spaced apart from the thrust plate 41 in an upward axial direction and bent to enclose an outer side surface of the sleeve 22 to thereby be coupled to the thrust plate 41, wherein the sealing cap 60 may be provided with a to sealing part 60a having concave parts 60b and convex parts 60c alternately formed along an inner peripheral surface thereof in a radial direction.

The present invention relates to a sealing structure capable of improving sealing force of an operating fluid stored in the sealing cap 60 coupled to the thrust plate 41. Particularly, through a structural shape of the concave parts 60b and the convex parts 60c formed at the inner peripheral surface of the sealing cap 60, the operating fluid for the fluid dynamic pressure bearing is more efficiently sealed and a surface that the operating fluid contacts is reduced from the center of the motor toward the outside of the motor, thereby making it possible to prevent an asymmetrical flow of the operating fluid. The structure of the sealing part 60a according to the preferred embodiment of the present invention may be similarly applied to another sealing structure according to another preferred embodiment of the present invention to be described below as well as a sealing structure through the sealing cap 60 according to the preferred embodiment of the present invention. Hereinafter, a detailed preferred embodiment of the present invention will be described by describing features and associated configurations of the present invention.

The shaft 11 forms the center axis around which the spindle motor rotates and has generally a cylindrical shape. Although the case in which the thrust plate 41 is inserted into an upper end portion of the shaft 11 so as to be perpendicular to the axial direction is shown in FIG. 1, the thrust plate 41 may be inserted into a lower end portion of the shaft 11 so as to be perpendicular to the axial direction as well as the upper end portion of the shaft 11. In order to fix the thrust plate 41 to the shaft 11, separate laser welding, or the like, may be performed. However, it is obvious to those skilled in the art that the thrust plate 41 may be press-fitted into and be coupled to the shaft 11 by being applied with a predetermined pressure. In order to form a thrust dynamic pressure bearing part 40 by the fluid dynamic pressure bearing, dynamic pressure may be generated between the sleeve 22 and one surface of a hub 12 facing the sleeve 22 without a separate thrust plate 41.

The sleeve 22, which is to rotatably support the shaft 11, may support the shaft 11 so that the upper end of the shaft 11 is protruded in the upward axial direction and have a hollow cylindrical shape, such that that it may receive the shaft 11 therein by inserting the shaft 11 into a hollow thereof, as shown in FIG. 1. The sleeve 22 may be formed by forging copper (Cu) or aluminum is (Al) or sintering a Cu-Fe-based alloy powder or a SUS-based powder. A radial dynamic pressure bearing part 50 by fluid dynamic pressure may be formed between an inner peripheral surface 22a of the sleeve 22 and an outer peripheral surface 11a of the shaft 11 facing the sleeve 22. In order to form the radial dynamic pressure bearing part 50, a radial dynamic pressure generation groove (not shown) is formed in an inner peripheral surface 22a of the sleeve 22 facing an outer peripheral surface 11a of the shaft 11, and an operating fluid (for example, oil, or the like) is stored between the inner peripheral surface 22a of the sleeve 22 and the outer peripheral surface 11a of the shaft 11. The radial dynamic pressure generation groove generates fluid dynamic pressure using the operating fluid stored between the sleeve 22 and the shaft 11 at the time of rotation of the shaft 11, thereby making it possible to allow the shaft 11 and the sleeve 22 to be maintained in a state in which they do not contact each other. The radial dynamic pressure generation groove may also be formed in the outer peripheral surface 11a of the shaft 11 forming the radial dynamic pressure bearing part 50 by the fluid dynamic pressure.

The thrust plate 41 is press-fitted into the shaft 11 so as to be perpendicular to the axial direction of the shaft 11. The thrust plate 41 may be formed integrally with the shaft 11 or be formed separately from the shaft 11 and then coupled to the shaft 11. The thrust plate 41, which is to form the thrust dynamic pressure bearing part 40, may include the dynamic pressure generation groove (not shown) formed in the upper surface thereof in the axial direction as described above. Since other detailed descriptions are overlapped with the above-mentioned description, it will be omitted.

The sealing cap 60 may be spaced apart from the thrust plate 41 in the upward axial direction and be bent so as to enclose the outer side surface of the sleeve 22 to thereby be coupled to the thrust plate 41 (See FIG. 2). The sealing cap 60 includes a first plate part 61 coupled to the thrust plate 41 and supported by the thrust plate 41 in the upward axial direction and a second plate part 62 formed by bending an outer side end of the first plate part 61 in a downward axial direction, as shown in FIG. 2. The first plate part 61 is positioned at an upper end portion of the thrust plate 41 so as to be spaced from the thrust plate 41, and the second plate part 62 is extended from the first plate part 61 and bent in the downward axial direction to thereby be coupled to the outer side surface of the sleeve 22. Particularly, according to the preferred embodiment of the present invention, the sealing part 60a having the concave part 60b and the convex part 60c may be further formed at the inner side surface of the sealing cap 60 in the radial direction. The concave part 60b and the convex part 60c may be formed at the inner side surface of the sealing cap 60 in the radial direction and formed along the circumferential surface of the sealing cap 60. As shown in FIG. 2, the concave part 60b and the convex part 60c are formed along the circumference of the sealing cap 60 at the inner side surface of the sealing cap 60, such that an interface by the operating fluid may also be formed on the concave part 60b. The interface of the operating fluid is formed so that a filling amount of the operating fluid in the radial direction is increased from an upper portion of the concave part 60b in the axial direction toward a lower portion thereof in the axial direction (See FIG. 2).

Describing a detailed structure of the sealing part 60a according to the preferred embodiment of the present invention, the concave part 60b may have a groove shape in which a width thereof is narrowed toward an inner side surface thereof and the convex part 60c may be formed to be protruded so that a width thereof is narrowed toward an outer side surface thereof, as shown in FIGS. 3 and 4. For example, the sealing part 60a may have a saw-tooth shaped sealing structure. The sealing part 60a is formed on the inner side surface of the first plate part 61 of the sealing cap 60 toward the shaft 11 in the radial direction to form a three-dimensional interface of the operating fluid, thereby making it possible to further improve sealing efficiency and sealing force of the operating fluid. In addition, a space spaced between the first plate part 61 of the sealing cap 60 and the thrust plate 41 needs not to be necessarily formed so as to be tapered, thereby making it possible to improve a degree of freedom in design of the sealing cap 60.

In addition, the spindle motor according to the preferred embodiment of the present invention may include a base 21 coupled to an outer peripheral surface of the sleeve 22 so as to support the sleeve 22 and having a core 23 mounted on an inner peripheral surface thereof, the core 23 having a coil 23a wound therearound, and the rotor hub 12 having the shaft 11 coupled to the center portion, bent in the downward axial direction at one side end thereof, and having a rotor magnet 13 mounted on an inner side surface of the bent portion thereof so as to correspond to the core 23 in the radial direction.

The base 21 has one side surface coupled to the outer peripheral surface of the sleeve 22 so as to enclose the outer peripheral surface of the sleeve 22 so that the sleeve 22 including the shaft 11 is coupled to an inner side thereof. The base 21 has the core 23 coupled to the other surface thereof opposite to one surface thereof, so as to correspond to the rotor magnet 13 mounted on an inner side surface of a side portion of the hub 12 in the radial direction, wherein the core 23 has the coil 23a wound therearound. The base 21 may serve to support the entire structure of the spindle motor at a lower portion of the spindle motor and be manufactured by press processing or die-casting. The press processing may be performed using various metals such as aluminum, steel, and the like, particularly, a metal material having rigidity. A conductive adhesive (not shown) for conduction between the base 21 and the sleeve 22 may be connected to and formed on a lower end surface of a portion at which the base 21 and the sleeve 22 are bonded to each other. This conductive adhesive allows excessive charges generated at the time of operation of the motor to be conducted to the base 21 to flow to the outside, thereby making it possible to improve reliability of the motor operation.

The core 23 is generally formed by stacking a plurality of thin metal plates and is fixedly disposed on the base 21 including a flexible printed circuit board 70. A plurality of through-holes 21a through which the coil 23a wound around the core 23 is led and passes may be formed in a lower end surface of the base 21, respectively, and the coil 23a led through the through-holes 21a may be soldered to the flexible printed circuit board 70 to thereby be supplied with external power. In order to insulate the coil 23a passing through the through-hole 21a of the base 21 and the base 21 from each other, an insulating sheet 21b may be formed at an inlet portion of the through-hole 21a.

The hub 12, which is to mount and rotate an optical disk (not shown) or a magnet disk (not shown) thereon, has the shaft 11 coupled integrally therewith at the center thereof and is coupled to the upper portion of the shaft 11 so as to correspond to the upper end surface of the sleeve 22 in the axial direction. The hub 12 has the rotor magnet 13 mounted on the inner side surface of the side portion thereof so as to face the core 23 of the base 21 to be described below in the radial direction. The core 23 generates a magnetic flux while forming a magnetic field when current flows. The rotor magnet 13 facing the core 23 includes N and S poles repeatedly magnetized in a circumferential direction to form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12.

As shown in FIG. 1, the cover member 30 is coupled to the sleeve 22 in order to cover an axial lower end surface of the sleeve 22 including the shaft 11. The cover member 30 includes a dynamic pressure generation groove (not shown) formed in an inner side surface thereof facing the lower end surface 11b of the shaft 11, thereby making it possible to form a thrust dynamic pressure bearing part. The cover member 30 may have a structure in which it is coupled to a distal end of the sleeve 22, such that the oil, which is the operating fluid, may be stored therein.

A spindle motor according to another preferred embodiment of the present invention is configured to include a shaft 11 forming the center of rotation of the motor, a sleeve 22 receiving the shaft 11 therein and rotatably supporting the shaft 11, and a hub 12 coupled to an upper portion of the shaft 11 in an axial direction and having a protrusion part 12a formed so as to face an outer peripheral surface of the sleeve 22 in a radial direction, wherein a lower end surface of the protrusion part 12a in the axial direction is provided with a sealing part 60a having concave parts 12b and convex parts 12c alternately formed along a circumference thereof.

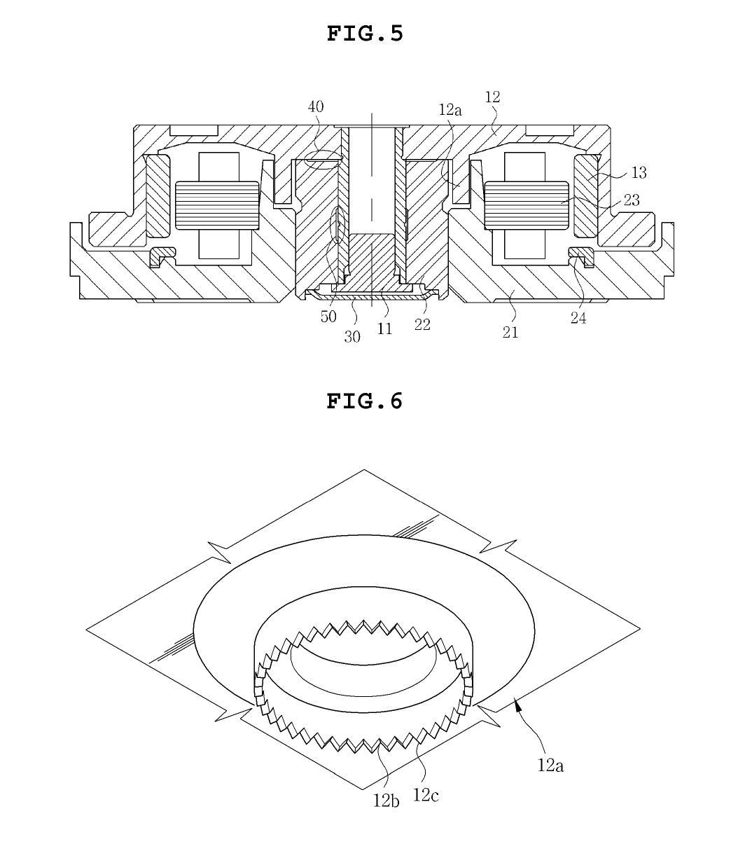

The spindle motor according to another preferred embodiment of the present invention is different in a structural shape of a sealing part 60a from that of the spindle motor according to the preferred embodiment of the present invention described above. As shown in FIG. 5, the protrusion part 12a protruded from the hub 12 in a downward axial direction and spaced apart from an outer side surface of the sleeve 22 is formed. A space spaced between the protrusion part 12a and the sleeve 22 may be formed with an interface of an operating fluid.

Here, in the sealing part 60a at which the interface of the operating fluid is formed, as shown in FIG. 6, the concave parts 12b and the convex parts 12c may be alternately formed at the lower end surface of the protrusion part 12a in the axial direction. Since the concave part 12b and the convex part 12c have the same shapes as those of the concave part 60b and the convex part 60c of the sealing part 60a of the spindle motor according to the preferred embodiment of the present invention described above, a detailed description thereof will be omitted. However, the sealing part 60a of the spindle motor according to the present embodiment is formed at the lower end surface of the protrusion part 12a in the axial direction, which is structurally different from that of the spindle motor according to the preferred embodiment of the present invention formed at the inner side of the sealing cap 60 in the radial direction.

Even in the present embodiment, the sealing part 60a in which the concave parts 12b and the convex parts 12c are alternately formed is formed to form a three-dimensional interface of the operating fluid, thereby making it possible to further improve sealing efficiency of the operating fluid and store and seal the operating fluid using a more simple structure. Particularly, a structure in which the space spaced between an inner side surface of the protrusion part 12a protruded from the hub 12 and an outer side surface of the sleeve 22 facing the inner side surface of the protrusion part 12a is formed to be tapered in order to seal the operating fluid is selectively applied, thereby making it possible to increase a degree of freedom in design of the sealing part 60a. That is, in both of a structure in which the space spaced between the inner side surface of the protrusion part 12a and the outer side surface of the sleeve 22 facing the inner side surface of the protrusion part 12a is formed to be in parallel in the axial direction and the structure in which the space is formed to be tapered, the sealing part 60a according to the preferred embodiment of the present invention is applied, thereby making it possible to store and seal the operating fluid.

Since other components and acting effects of another preferred embodiment of the present invention are overlapped with those of the preferred embodiment of the present invention described above, a detailed description thereof will be omitted.

Components of the spindle motor according to the preferred embodiment of the present invention and an operation relationship therebetween will be briefly described below with reference to FIG. 1.

A rotor 10 includes the shaft 11 becoming a rotation axis and rotatably formed and the hub 12 having the rotor magnet 13 attached thereto, and a stator 20 includes the base 21, the sleeve 22, the core 23, and a pulling plate 24. Each of the core 23 and the rotor magnet 13 is attached to an outer side of the base 21 and an inner side of the hub 12 while facing each other. When current is applied to the core 23, a magnetic flux is generated while a magnetic field is formed. The rotor magnet 13 facing the core 23 includes repeatedly magnetized N and S poles to form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12, such that the spindle motor according to the preferred embodiment of the present invention is driven. In addition, in order to prevent floating at the time of driving of the motor, the pulling plate 24 is formed on the base 21 so as to correspond to the rotor magnet 13 in the axial direction. The pulling plate 24 and the rotor magnet 13 have attractive force acting therebetween, thereby making it possible to stably rotate the motor.

As set forth above, according to the preferred embodiment of the present invention, the sealing force of the operating fluid sealing part of the fluid dynamic pressure bearing may be further improved.

In addition, the three-dimensional interface of the operating fluid may be formed at the sealing part of the fluid dynamic pressure bearing, such that the sealing efficiency of the operating fluid may be improved and the reliability of the sealing may be secured.

Further, the inner side surface in the radial direction in the sealing cap forming the sealing part of the fluid dynamic pressure bearing is formed in the saw-tooth structure, such that the sealing efficiency of the operating fluid may be further improved.

Moreover, the reliability of the storage and the sealing of the operating fluid of the fluid dynamic pressure bearing are improved, such that the operational performance of the motor using the fluid dynamic pressure bearing may be improved and the reliability of the motor driving may be secured.

Furthermore, the sealing cap for the storage and the sealing of the operating fluid of the fluid dynamic pressure bearing is structurally changed, such that easiness in manufacturing the sealing part of the spindle motor and productivity of the spindle motor may be improved.

In addition, the sealing part having the saw-tooth shape is formed at the corresponding surface in the radial direction in the sealing cap for sealing the operating fluid forming the fluid dynamic pressure bearing to reduce a contact surface of the operating fluid from the rotation axis toward the outside, thereby making it possible to prevent an asymmetrical flow of the operating fluid.

In addition, the asymmetrical flow of the operating fluid forming the fluid dynamic pressure bearing is prevented, thereby making it possible to secure the reliability in driving the motor using the fluid dynamic pressure bearing.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be to disclosed by the accompanying claims.

What is claimed is:

1. A spindle motor comprising:
a shaft forming the center of rotation of the motor;
a sleeve receiving the shaft therein and rotatably supporting the shaft;
a thrust plate press-fitted into the shaft so as to be perpendicular to an axial direction of the shaft; and
a sealing cap spaced apart from the thrust plate in an upward axial direction and bent to enclose an outer side surface of the sleeve to thereby be coupled to the thrust plate,
wherein the sealing cap is provided with a sealing part having concave parts and convex parts alternately formed along an inner peripheral surface thereof in a radial direction.

2. The spindle motor as set forth in claim 1, wherein the concave part of the sealing part has a groove shape in which a width thereof is narrowed toward an inner side surface thereof and the convex part of the sealing part is formed to be protruded so that a width thereof is narrowed toward an outer side surface thereof.

3. The spindle motor as set forth in claim 1, wherein the concave part and the convex part are formed in a saw-tooth shape.

4. The spindle motor as set forth in claim 1, wherein the sealing cap includes:
a first plate part facing the thrust plate; and
a second plate part extended from the first plate part and bent in a downward axial direction to thereby be coupled to the outer side surface of the sleeve, and
wherein the sealing part is formed along an inner peripheral surface of the first plate part in the radial direction.

5. The spindle motor as set forth in claim 4, wherein the first plate part and the thrust plate are spaced from each other so as to face each other in parallel with each other.

6. The spindle motor as set forth in claim 4, wherein a spaced space formed by the first plate part and the thrust plate facing each other is formed so as to have an axial interval gradually increased toward the center of rotation of the motor.

7. The spindle motor as set forth in claim 4, wherein the concave part of the sealing part has a groove shape in which a width thereof is narrowed toward an inner side surface thereof and the convex part of the sealing part is formed to be protruded so that a width thereof is narrowed toward an outer side surface thereof.

8. The spindle motor as set forth in claim 4, wherein the concave part and the convex part of the sealing part are formed in a saw-tooth shape.

9. A spindle motor comprising:
a shaft forming the center of rotation of the motor;
a sleeve receiving the shaft therein and rotatably supporting the shaft; and
a hub coupled to an upper portion of the shaft in an axial direction and having a protrusion part formed so as to face an outer peripheral surface of the sleeve in a radial direction,
wherein a lower end surface of the protrusion part in the axial direction is provided with a sealing part having concave parts and convex parts alternately formed along a circumference thereof.

10. The spindle motor as set forth in claim 9, wherein the concave part of the sealing part has a groove shape in which a width thereof is narrowed toward an inner side surface thereof and the convex part of the sealing part is formed to be protruded so that a width thereof is narrowed toward an outer side surface thereof.

11. The spindle motor as set forth in claim 9, wherein the concave part and the convex part of the sealing part are formed in a saw-tooth shape.
